(19) United States
(12) Patent Application Publication
(10) Pub. No.: US 2021/0180885 A1
(43) Pub. Date: Jun. 17, 2021

(54) REPRESENTATIVE VOLUME ELEMENTS FOR HEAT EXCHANGERS WITH FLOW AREA CONTROL

(71) Applicant: United Technologies Corporation, Farmington, CT (US)

(72) Inventors: James F. Wiedenhoefer, Windsor, CT (US); Jacob C. Snyder, Manchester, CT (US)

(21) Appl. No.: 16/714,275

(22) Filed: Dec. 13, 2019

(51) Int. Cl. F28F 13/06; G06F 30/10

(52) U.S. Cl. CPC F28F 13/06; G06F 30/10; G06F 2111/10; F28F 2250/10; F28F 2280/00; F28F 2200/00

(57) ABSTRACT

A component, and a method of forming a component, including a plurality of representative volume elements, each of the representative volume elements abutting at least one other representative volume element to form the component. Each of the representative volume elements includes at least one dividing structure bound by surfaces offset from a parting surface. The shape and contour of the parting surface defined by a mathematical expression that equals a non-zero constant, the mathematical expression selected to define a triply periodic surface when the expression equals zero.

### BACKGROUND

This disclosure relates generally to component volumes partitioned by representative volume elements (RVEs) that define unequal cross-sectional flow areas, and more particularly to forming a heat exchanger core formed by representative volume elements (RVEs) in which the RVEs define different cross-sectional flow areas expressed as an area ratio.

Heat exchanger design often seeks to maximize the transmission of heat flux from one fluid to another or among multiple fluids within the heat exchanger core. To this end, many heat exchanger designs increase the surface area in contact between fluids within the heat exchanger core. Heat exchanger core designs having a relatively high surface area to volume ratio, or heat exchanger density, are referred to as compact heat exchangers. While large surface areas in compact heat exchangers increase heat transfer efficiency, the resulting relatively small fluid passage size is more susceptible to fouling and high pressure losses, which can be undesirable in some applications.

Recent attempts to address these disadvantages include forming heat exchanger cores by replicating representative volume elements (RVE), also known as representative elementary volumes (REV), within the core volume of heat exchangers. A representative volume element (RVE) or representative elementary volume (REV) is the smallest unit volume representation of a more complicated geometry. For periodic structures and materials, the RVE is the smallest unit volume that can be replicated in at least one direction of three-dimensional space to produce the overall structure. RVEs that can be replicated in three orthogonal directions are termed triply periodic structures. Some of these triply periodic RVE structures produce dissimilar boundary faces and require a particular orientation, or crystalline structure, with respect to the adjacent RVEs to form a unitary structure. Other RVEs have identical boundary faces, permitting the RVE to be rotated with respect to the adjacent RVEs while maintaining a unitary structure otherwise known as orientation independent structures.

In some applications, RVE geometry utilizes, or is derived from, a minimal surface. Minimal surfaces are surfaces with a minimized local area. In other words, a minimal surface is a surface that has the smallest possible surface area for a given boundary. Additionally, minimal surfaces have a zero mean curvature, i.e., the sum of the principle curvatures at each point is zero. One subset of such RVEs are triply periodic minimal surfaces (TPMS) that are RVEs in which the dividing surface is a minimal surface that produces a triply periodic unit structure. Examples of triply periodic unit structures based on TPMS surfaces include the structures based on Schwarz-D, Schoen-G, Schwarz-P, and Schoen IWP surfaces (depicted by FIGS. 1A, 1B, 1C, and 1D, respectively) known in the art, each structure being based on a thickened minimal surface.

While RVEs have improved fouling performance and reduced pressure loses in compact heat exchangers, conventional RVE configurations, such as those based on a thickened minimal surface, produce equal cross-sectional flow areas. However, in some heat exchanger applications, heat exchanger efficiency can be improved by biasing the cross-sectional flow area between two fluid paths, or among multiple fluid paths. As such, a need exists for producing RVE-based components and, in particular, heat exchanger cores with unequal RVE divisions and unequal cross-sectional flow area divisions.

### SUMMARY

In one example, a component can be formed by representative volume elements (RVEs) in which each RVE includes a first dividing structure partitioning the RVE into two discrete regions. The first dividing structure is bounded by first and second surfaces defined by offsetting a parting surface in opposite directions. The parting surface is defined by a mathematical expression that equals a non-zero first constant. Characteristically, the mathematical expression defines a triply periodic surface or, in some embodiments, a triply periodic minimal surface if the mathematical expression equals zero. In a further example, a heat exchanger can include a core formed by the above component, which places two fluids in a heat exchange relationship and biases the cross-sectional flow areas of the heat exchanger core in favor of one of the two fluid paths.

In another example, the component can include a second dividing structure that cooperates with the first dividing structure to partition each RVE into three discrete regions. The second dividing structure is also based on a parting surface defined by the mathematical expression, but differs in that the mathematical expression equals a non-zero second constant different from the first constant. A heat exchanger core constructed from the above component permits cross-sectional flow area ratios between the first and second regions and between the second and third regions to be greater than or less than 1.0 at the boundary faces of the RVEs. In a particular example in which two fluids are placed in a heat exchange relationship, an area ratio equal to the summation of the first and third outer cross-sectional flow areas of the RVE divided by the inner cross-sectional flow area of the second region can be greater than or less than 1.0 or, in other words, biased in favor of one of the two fluid paths.

In another example, the component can include a third dividing structure to partition each RVE into four discrete regions. The third dividing structure is based on a third parting surface defined by the mathematical expression equal to a non-zero third constant different from the first constant and different from the second constant. Heat exchanger cores formed by components of this type permit area ratios between two of any of the four regions to be greater than or less than 1.0. In a particular example of this type, two of the regions can be disposed between regions containing fluid to form buffer zones.

### BRIEF DESCRIPTION OF THE DRAWINGS

FIG. 1A is an isometric view of a representative volume element (RVE) having a dividing structure based on a Schwarz-D surface.

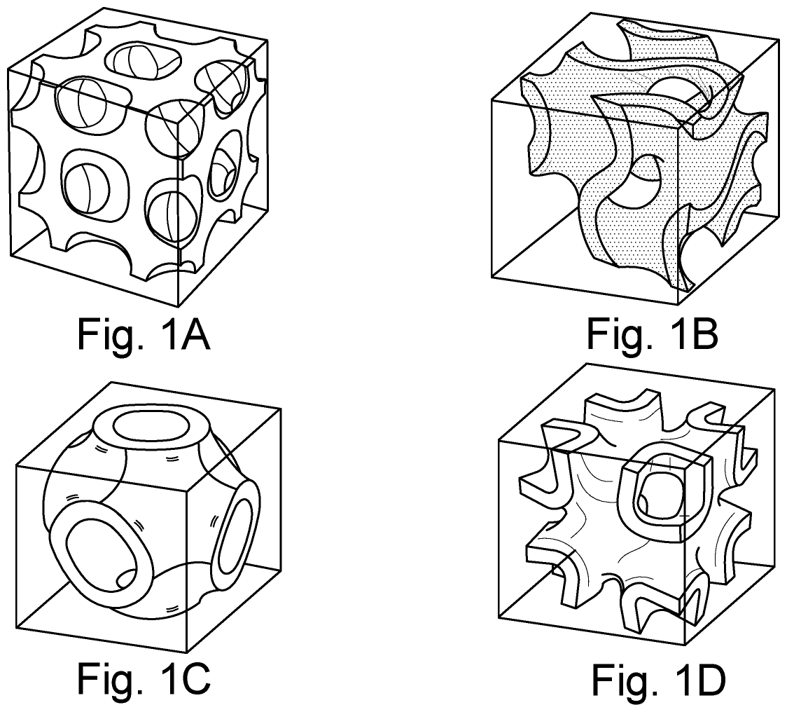

FIG. 1B is an isometric view of a representative volume element (RVE) having a dividing structure based on a Schoen-G surface.

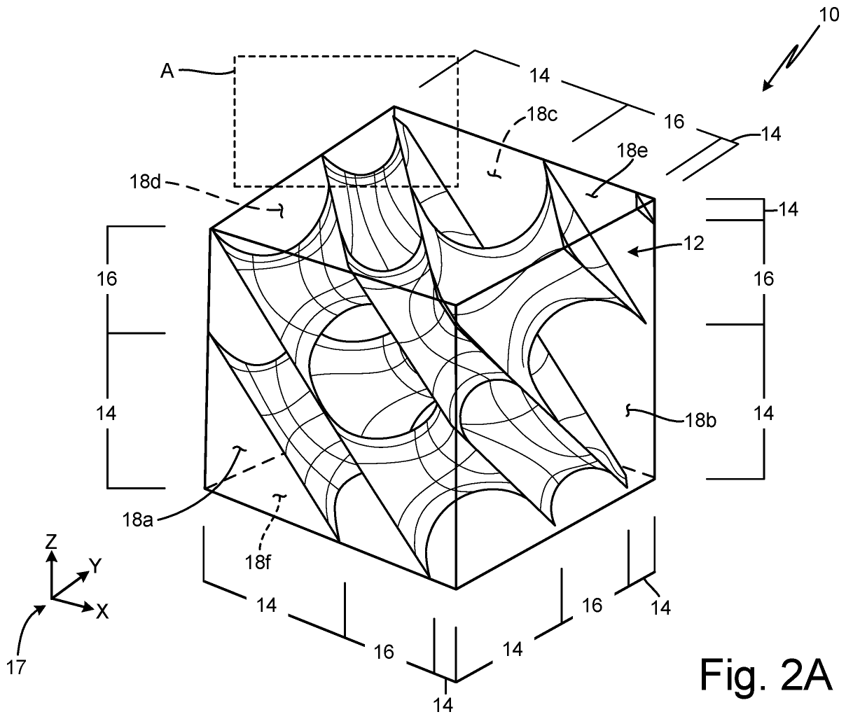

FIG. 1C is an isometric view of a representative volume element (RVE) having a dividing structure based on a Schwarz-P surface.

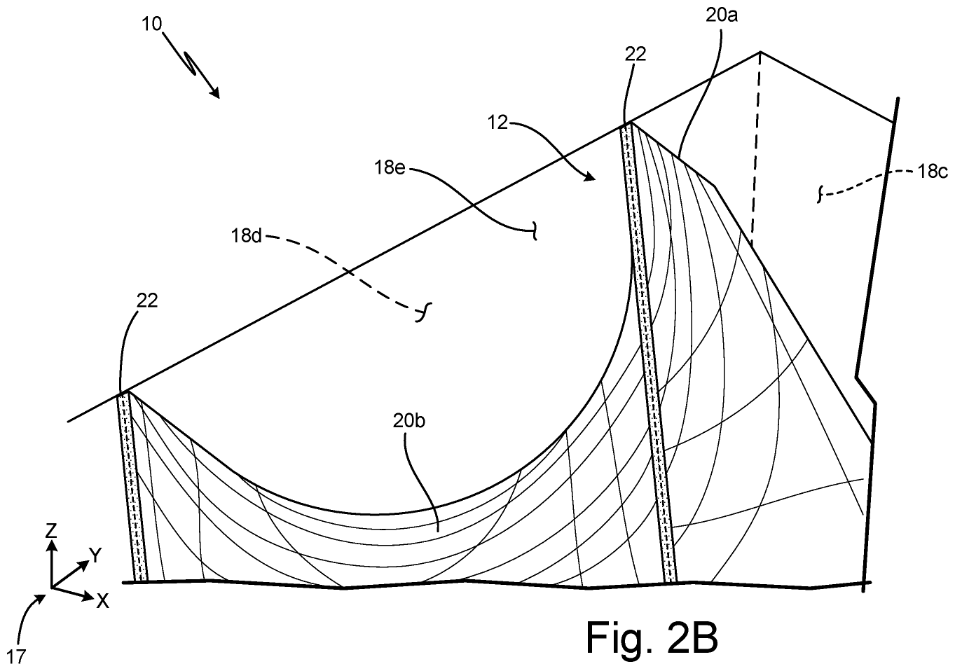

FIG. 1D is an isometric view of a representative volume element (RVE) having a dividing structure based on a Schoen IWP surface.

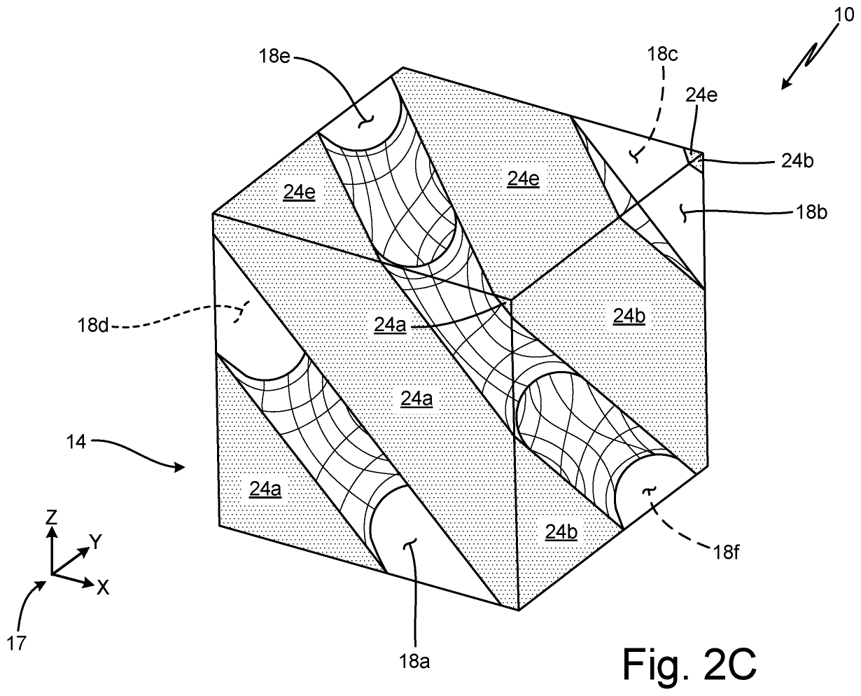

FIG. 2A is an isometric view of a representative volume element (RVE) having a dividing structure based on a Schwarz-D surface but is offset within the RVE to define two regions with unequal cross-sectional flow areas.

FIG. 2B is an enlarged isometric view of zone A depicted in FIG. 2A.

FIGS. 2C and 2D are isometric views of each of the regions defined by the RVE depicted in FIG. 2A.

FIG. 3A is an isometric view of a representative volume element (RVE) having two dividing structures based on a Schwarz-D surface except each structure is offset by a different amount within the RVE relative to the Schwarz-D surface to define three discrete regions of unequal cross-sectional flow areas.

FIG. 3B is an enlarged isometric view of zone B depicted in FIG. 3A.

FIGS. 3C, 3D, and 3E are isometric views of each of the regions defined by the RVE depicted in FIG. 3A.

FIG. 4 is a schematic view of a representative volume element (RVE) having three dividing structures based on a Schwarz-D surface except each structure is offset by a different amount within the RVE relative to the Schwarz-D surface to define four discrete regions.

FIG. 5A is a schematic view of an exemplary system implementing a heat exchanger core formed by a plurality of RVEs depicted by FIGS. 2A-2D.

FIG. 5B is a schematic view of an exemplary system implementing a heat exchanger core formed by a plurality of RVEs depicted by FIGS. 3A-3E.

FIG. 5C is a schematic view of an exemplary system implementing a heat exchanger core formed by a plurality of RVEs depicted by FIG. 4.

FIG. 6 is a flow chart describing steps for forming a component comprising a plurality of RVEs.

### DETAILED DESCRIPTION

As disclosed herein are components formed by representative volume elements (RVEs) characterized by discrete regions having unequal cross-sectional flow areas. Each representative volume element includes at least one dividing structure bound by two surfaces, each surface offset from opposite sides of a parting surface. The parting surface is a surface defined in three-dimensional space by a mathematical expression that equals a constant. Further, the selected mathematical expression is one that defines a triply periodic surface, or a triply periodic minimal surface (TPMS), when the expression equals zero. When the mathematic expression of the parting surface equals zero, the dividing structure bound by surfaces offset from the parting surface has a shape and contour that is similar to the parting surface and bounds discrete regions of equal volume and equal cross-sectional flow area of the RVE. However, in other embodiments, the mathematical expression equals a non-zero constant to offset the parting surface within the RVE such that the dividing structure bounds discrete regions of unequal volume and unequal cross-sectional flow area of the RVE.

Additional dividing structures can be added to the RVE to create additional discrete regions within the RVE, each additional dividing structure defined in a similar manner to the first dividing structure. As a result, the RVE can include one or more dividing structures that partition the RVE into multiple discrete regions and cross-sectional flow areas, the proportions of which can be varied by selecting different constants that equal the mathematical expression. When such components are used to construct heat exchanger cores, the fluid paths can be tailored to application-specific requirements of the heat exchanger. For instance, using RVE with unequal cross-sectional flow areas, the cross-sectional flow area ratio between two fluid paths can be tailored to account for differences in fluid viscosity, flow rate, temperature, pressure, and the like, and to improve heat exchanger efficiency.

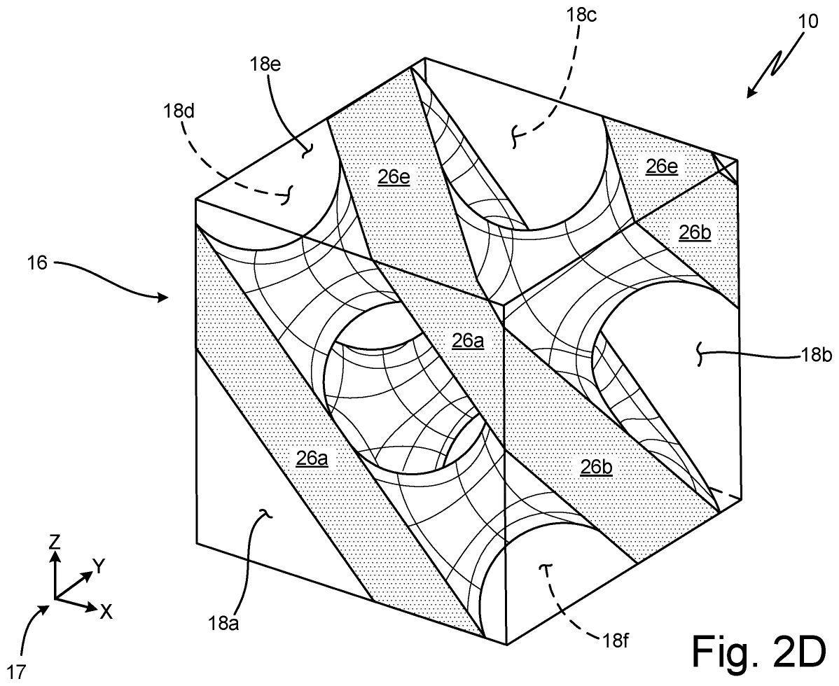

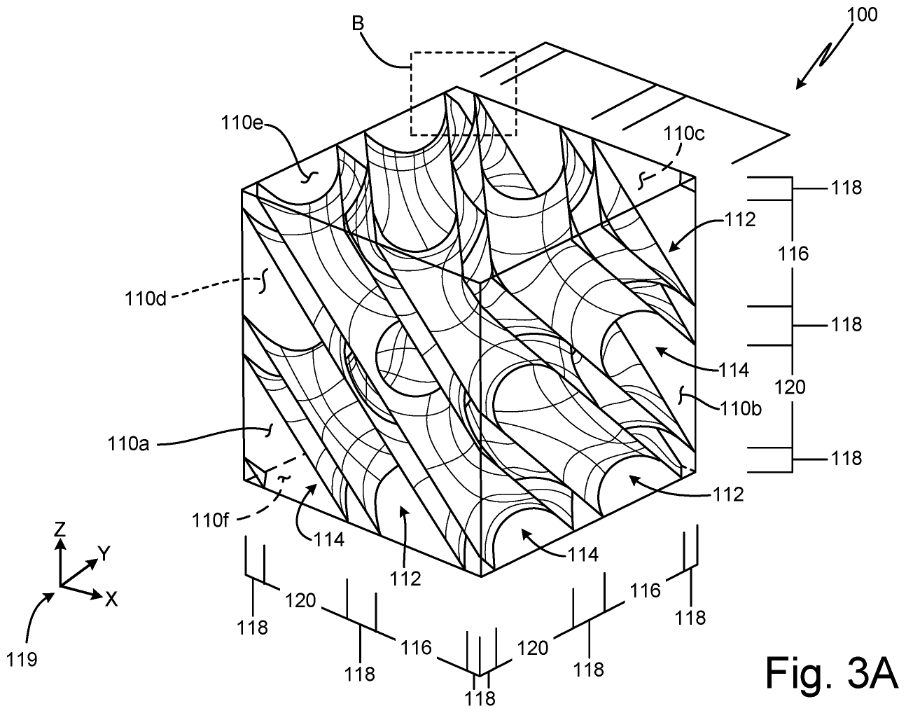

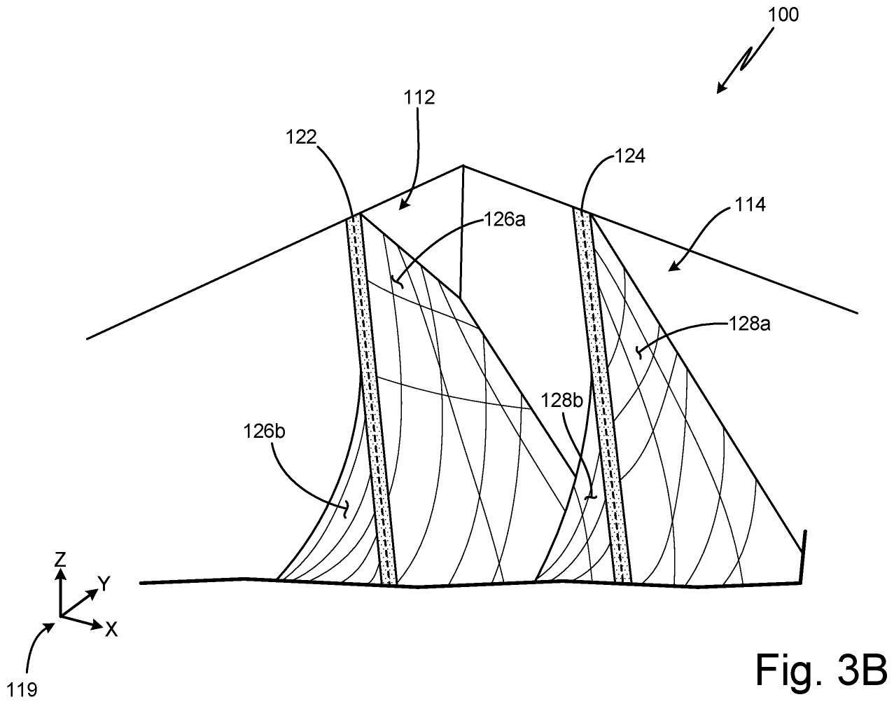

FIG. 2A is an isometric view of representative volume element (RVE) 10 that includes dividing structure 12. Dividing structure 12 extends within RVE 10 to divide the internal volume of RVE 10 into two discrete regions 14 and 16 as noted along boundary faces 18a, 18b, 18c, 18d, 18e, and 18f, which enclose RVE 10. Region 14 defines a flow path within RVE 10 that does not fluidly communicate with region 16. That is to say, fluid flowing through region 14 does not mix with fluid flowing within region 16.

Further, dividing structure 12 is a triply periodic structure such that RVE 10 can be replicated along mutually orthogonal X, Y, and Z axes of coordinate system 17 to form a component. As depicted in FIG. 2A, the X-axis of coordinate system 17 is normal to boundary surfaces 18b and 18d. The Y-axis of coordinate system 17 is normal to boundary surfaces 18a and 18c, and the Z-axis of coordinate system 17 is normal to surfaces 18e and 18f. Replicating RVE 10 along one or more axis of coordinate system 17 will produce a component defined by an array or assembly of a plurality of representative volume elements 10, adjacent elements having abutting boundary faces. Dividing structures of adjacent representative volume elements 10 form continuous dividing structures through the component, regions 14 and 16 communicating with corresponding regions 14 and 16 of adjacent RVEs 10 in order to from continuous and discrete flow paths through the component.

While the depicted dividing structure 12 is derived from the Schwarz-D surface, dividing structure 12, or any of the other dividing structures disclosed herein, can be based on a different implicit surface expression or an explicit surface expression. For instance, dividing structure 12 can be based on a Schoen-G, Schwarz-P, or Schoen-IWP surfaces, among other possible minimal surfaces as well as explicitly defined surfaces of any shape so long as the surface has the required periodic characteristic. The Schwarz-D, Schoen-G, Schwarz-P, and Schoen IWP surfaces are given by equations 1, 2, 3, and 4 below expressed as a mathematical expression that equals zero. These base surfaces, sometimes referred to as zero surfaces, are triply periodic minimal surfaces.

Schwarz-D cos(x)cos(y)cos(z)−sin(x)sin(y)sin(z)=0 (Equation 1)

Schoen-G cos(x)sin(y)+cos(y)sin(z)+cos(z)sin(x)=0 (Equation 2)

Schwarz-P cos(x)+cos(y)+cos(z)=0 (Equation 3)

Schoen IWP 2 cos(x)cos(y)+2 cos(x)cos(z)+2 cos(y)cos(z)−cos(2x)−cos(2y)−(2z)=0 (Equation 4)

FIG. 2B is an enlarged view of zone A encompassed by the corner of RVE 10 defined by the intersection of boundary faces 18c, 18d, and 18e. Dividing structure 12 is bound by surfaces 20a and 20b. Surface 20a defines region 14, surface 20b defines region 16, and each of surfaces 20a and 20b is offset from parting surface 22 in opposite directions such that each point on surface 20a and each point on surface 20b is offset along a vector normal to corresponding points on parting surface 22. All points along surface 20a are offset by the same amount from parting surface 22, and similarly, all points along surface 20b are offset by the same amount from parting surface 22. Accordingly, surfaces 20a and 20b, and thus dividing structure 12, have a similar shape and a similar contour profile as parting surface 22.

An exemplary process for offsetting surfaces 20a and 20b from parting surface 22, or any other of the surfaces described herein that are offset from respective parting surfaces, is described by U.S. patent Ser. No. 16/353,206 entitled “METHOD OF CREATING A COMPONENT VIA TRANSFORMATION OF REPRESENTATIVE VOLUME ELEMENTS” and filed on Mar. 14, 2019 with the United States Patent and Trademark Office, which is incorporated by reference in its entirety. In this exemplary process, each parting surface of the representative volume element is mapped into the target, or component domain. For example, the component domain may be a heat exchanger core volume. Subsequently each parting surface is thickened to form a dividing structure (i.e. a solid wall) separating the fluid regions. Bounding surfaces of the dividing structure that are opposite each other along the thickness direction form surfaces offset from the parting surface (e.g., surfaces 20a and 20b). In this way, the thickness of the dividing structure is uniform throughout the representative volume element and, therefore, uniform through the component domain. A similar process can be applied to produce RVEs with additional dividing structures and, hence, components with additional parting walls, as will be described in further detail in subsequently-described embodiments.

In the embodiment depicted by FIGS. 2A, 2B, 2C, and 2D, parting surface 22 is an implicit surface defined by a mathematical expression that equals a non-zero constant. The mathematical expression selected for parting surface 22 is one that defines a triply periodic minimal surface when the expression equals zero (e.g., a surface defined by one of equations 1, 2, 3, and 4, among other possible triply periodic surfaces). In the example depicted by FIGS. 2A and 2B, equation 5 defines parting surface 22 where K is a non-zero constant. When non-zero constant K equals zero, the mathematical expression defines a Schwarz-D surface.

Parting Surface 22 cos(x)cos(y)cos(z)−sin(x)sin(y)sin(z)=K (Equation 5)

FIGS. 2C and 2D are isometric views of regions 14 and 16, respectively, shown without dividing structure 12. Region 14 intersects boundary faces 18a, 18b, 18c, 18d, 18e, and 18f to define cross-sectional flow areas 24a, 24b, 24c, 24d, 24e, and 24f, respectively, although only areas 24a, 24b, and 24e associated with boundary faces 18a, 18b, and 18e are shown in FIG. 2C. Similarly, region 16 intersects boundary faces 18a, 18b, and 18e to define cross-sectional flow areas 26a, 26b, and 26e shown in FIG. 2D, but also intersects hidden boundary faces 18c, 18d, and 18f to define cross-sectional flow areas 26c, 26d, and 26f not shown in FIG. 2D.

Since the dividing structure 12 is triply periodic, features of dividing structure 12, region 14, and region 16 defined at a boundary face of RVE 10 are identical to corresponding features of dividing structure 12, region 14, and region 16 defined at an opposite boundary face of RVE 10. For example, cross-sectional flow area 24a of region 14 is identical to cross-sectional flow area 24c on hidden face 18c of RVE 10. Similarly, cross-sectional flow areas defined on boundary face 18b are identical to corresponding cross-sectional flow areas on hidden boundary face 18d, and cross-sectional flow areas defined on boundary face 18e are identical to corresponding cross-sectional flow areas on hidden boundary face 18f. Likewise, faces of dividing structure 12 defined at boundary faces 18a-18f are identical to faces of dividing structure defined at an opposite boundary face.

The volume of region 14 is greater than the volume of region 16 as a result of offsetting parting surface 22 from the Schwarz-D base surface via selecting non-zero constant K. Further, as depicted, the cross-sectional flow areas of region 14 defined at boundary faces 18a-18f are greater than cross-sectional flow areas of region 16 defined at corresponding faces. For example, cross-sectional flow area 24a of region 14 is greater than corresponding cross-sectional area 26a of region 16 both defined at boundary face 18a. An area ratio defined at any one of the boundary faces 18a-18f of RVE 10 is equal to the cross-sectional flow area of region 14 divided by the cross-sectional flow area of region 16 defined at the selected boundary face. For instance, the ratio of area 24a divided by area 26a, or the area ratio taken at any of the other boundary faces 18b-18f, is greater than 1.0 as depicted in FIGS. 2C and 2D. Accordingly, the cross-sectional flow area of RVE 10 defined at boundary face 18a is biased in favor of region 14 and thus, area 24a of region 14 is greater than area 26a of region 16. Although, by varying the non-zero constant K of equation 5, other embodiments of RVE 10 can be formed in which the ratio of area 24a to area 26a, or the area ratio taken at any of the other boundary faces 18b-18f, can be less than one.

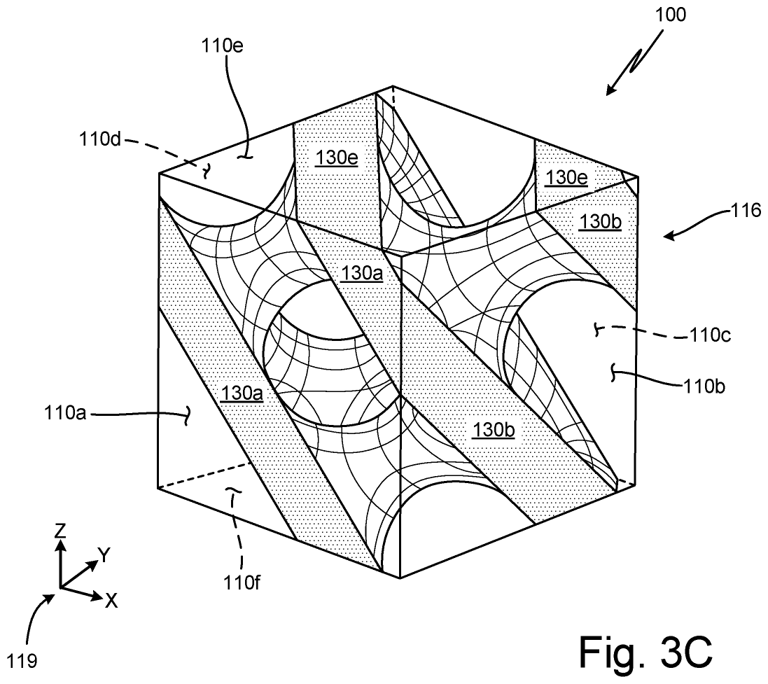

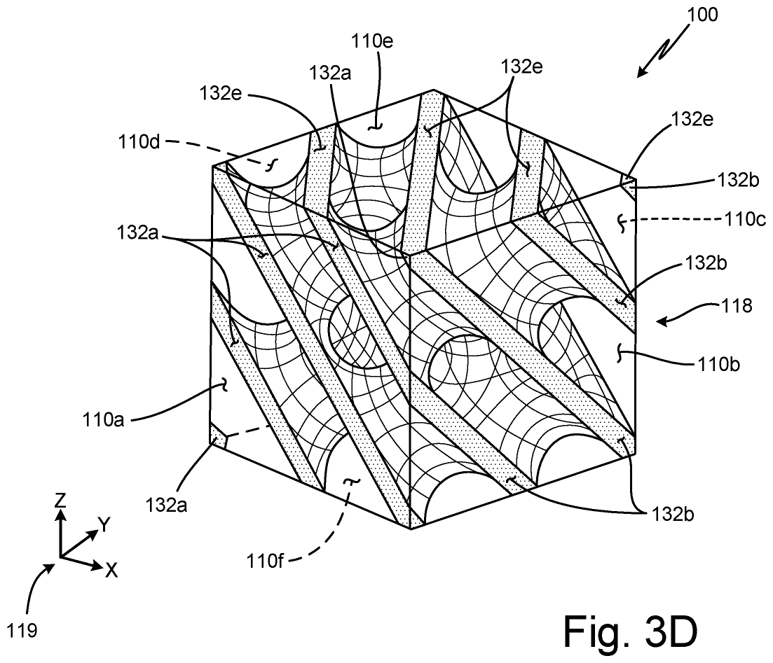

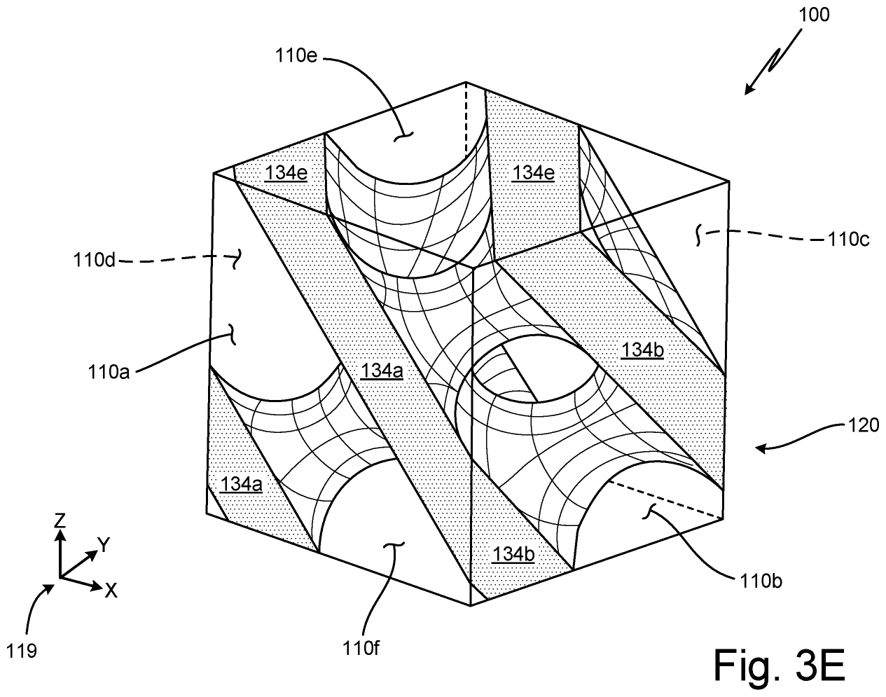

In other embodiments, RVE 10 can include one or more additional dividing structures to divide the volume of RVE 10 into three or more discrete regions. For example, FIG. 3A depicts representative volume element (RVE) 100 enclosed by boundary faces 110a, 110b, 110c, 110d, 110e, and 110f. RVE 100 includes dividing structures 112 and 114, which are offset from a Schwarz-D base surface and spaced from each other to partition RVE 100 into three discrete regions 116, 118, and 120 as indicated along the boundary faces of RVE 100. As shown in FIG. 3A, region 118 is disposed between regions 116 and 120. Further, each of regions 116, 118, and 120 is fluidly isolated from the other regions such that fluid within one region does not communicate with the fluid of the other regions. For instance, fluid supplied to region 116 does not enter region 118 or region 120. Similarly, fluid within region 118 does not fluidly communicate with regions 116 or region 120, and fluid within region 120 does not fluidly communicate with regions 116 and region 118.

Dividing structures 112 and 114 are triply periodic structures such that RVE 100 can be replicated along mutually orthogonal X, Y, and Z axes of coordinate system 119 to form a component. As depicted in FIG. 3A, the X-axis of coordinate system 119 is normal to boundary surfaces 110b and 110d. The Y-axis of coordinate system 119 is normal to boundary surfaces 110a and 110c, and the Z-axis of coordinate system 119 is normal to surfaces 110e and 110f. Replicating RVE 100 along one or more axis of coordinate system 119 will produce a component defined by an array or assembly of a plurality of representative volume elements 100, adjacent elements having abutting boundary faces. Dividing structures of adjacent representative volume elements 100 form continuous dividing structures through the component, regions 116, 118 and 120 communicating with corresponding regions 116, 118, and 120 of adjacent RVEs 100 in order to from continuous and discrete flow paths through the component.

FIG. 3B is an enlarged isometric view of RVE 100 showing the corner formed by the intersection of boundary faces 110c, 110d, and 110e and indicated in FIG. 3A by zone B. Dividing structures 112 and 114 are defined by parting surfaces 122 and 124, respectively, each parting surface 122 and 124 being defined by a mathematical expression that equals non-zero constants M and N, respectively Like the mathematical expression defining parting surface 22 of RVE 10, the mathematical expression defining each of parting surfaces 122 and 124 also defines a triply periodic minimal surface when constants M and N equal zero. For instance, parting surfaces 122 and 124 shown in FIG. 3B are based on a Schwarz-D surface expressed by equations 6 and 7 below, respectively, and in which M and N are non-zero constants.

Parting Surface 122 cos(x)cos(y)cos(z)−sin(x)sin(y)sin(z)=M (Equation 6)

Parting Surface 124 cos(x)cos(y)cos(z)−sin(x)sin(y)sin(z)=N (Equation 7)

Parting surfaces 122 and 124 are offset from the Schwarz-D, or zero surface, by a different amount to produce regions 116, 118, and 120 shown in FIG. 3A. As depicted by FIGS. 3A and 3B, non-zero constant M does not equal non-zero constant N. In some embodiments, both constants M and N are positive values, or negative values, of different magnitude, offsetting parting surfaces 122 and 124 from the same side of the Schwarz-D surface. In other embodiments, one of constants M and N is positive while the other constant is negative to offset parting surface 122 and 124 from opposite sides of the Schwarz-D surface. For example, in one particular embodiment, constants M and N have opposite sign and equal magnitude to offset parting surfaces 122 and 124 the same amount from opposite sides of the Schwarz-D surface. From these variations, it is evident that constants M and N can be any two non-zero and different values within the domain of the mathematical expression to produce three discrete regions.

Dividing structures 112 and 114 themselves are bound by surfaces offset from opposite sides of each parting surface 122 and 124. For instance, dividing structure 112 is bound by surfaces 126a and 126b. Each point along surfaces 126a and 126b are offset along a vector normal to a corresponding point on parting surface 122, albeit in opposite directions along the normal vector. Similarly, dividing structure 114 is bound by surfaces 128a and 128b in which each point along surfaces 128a and 128b are offset in opposite directions along a vector normal to a corresponding point on parting surface 124. Accordingly, dividing structures 112 and 114 as well as bounding surfaces 126a, 126b, 128a, and 128b have a shape and contour profile that is similar to the triply periodic minimal surface expressed by the mathematical expression, which in the depicted case, is a Schwarz-D surface.

FIGS. 3C, 3D, and 3E are isometric views of regions 116, 118, and 120 depicted without dividing structures 112 and 114. Each of regions 116, 118, and 120 intersect boundary faces 110a-f of RVE 100 to form cross-sectional flow areas. For example, region 116 intersects boundary faces 110a, 110b, 110c, 110d, 110e, and 110f to form cross-sectional flow areas 130a, 130b, 130c, 130d, 130e, and 130f of which flow areas 130a, 130b, and 130e are visible in FIG. 3C. Similarly, region 118 intersects boundary faces 110a-f to define cross-sectional flow areas 132a-f, and region 120 intersects boundary faces 110a-f to define cross-sectional flow areas 134a-f of which areas 132a, 132b, and 132e of region 118 are shown in FIG. 3D and areas 134a, 134b, and 134e of region 120 are shown in FIG. 3E.

Dividing structures 112 and 114 are also triply periodic like dividing structure 12 of RVE 10. As such, features of dividing structure 112, dividing structure 114, region 116, region 118, and region 120 defined at a boundary face of RVE 100 are identical to corresponding features of dividing structure 112, dividing structure 114, region 116, region 118, and region 120 defined at an opposite boundary face of RVE 100. For example, cross-sectional flow area 130a of region 116 is identical to cross-sectional flow area 130c on hidden face 110c of RVE 100. Similarly, cross-sectional flow areas defined on boundary face 110b are identical to corresponding cross-sectional flow areas on hidden boundary face 110d, and cross-sectional flow areas defined on boundary face 110e are identical to corresponding cross-sectional flow areas on hidden boundary face 110f. Likewise, faces of dividing structures 112 and 114 defined at boundary faces 110a-110f are identical to faces of respective dividing structures 112 and 114 defined at an opposite boundary face.

Representative volume elements partitioned into three discrete regions by two dividing structures, such as RVE 100, permit the cross-sectional flow area ratio between any two regions to be greater than or less than 1.0 or, in other words, to be biased towards one of the two regions. For applications that fluidly connect regions 116 and 120 to a single fluid source and fluidly connect region 118 to a different fluid source, the cross-sectional flow area ratio at boundary face 110a can be defined as the summation of cross-sectional areas 130a and 134a divided by cross-sectional flow area 132a. The cross-section flow area ratios of RVE 100 can be selected by varying non-zero constants M and N within the domain of the mathematical expression until the desired flow area ratio is achieved. As shown in FIGS. 3A-3E, cross-sectional flow areas of region 116 at each boundary face 110a-110f are approximately equal to corresponding cross-sectional flow areas of region 120. Further, cross-sectional flow areas of region 118 at each boundary face 110a-110f are less than corresponding cross-sectional flow areas of either region 116 or region 120.

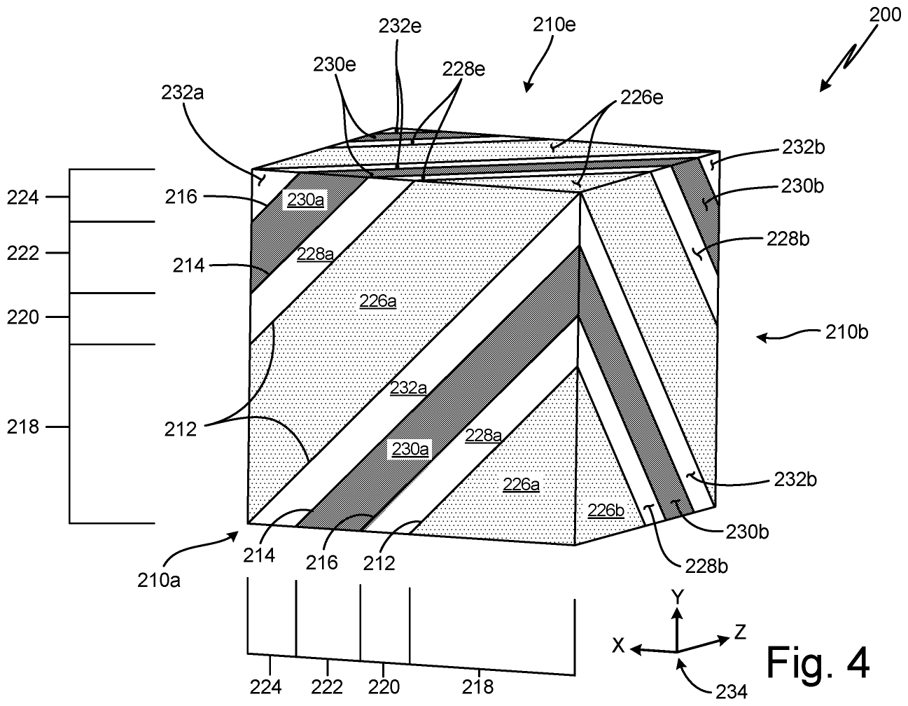

FIG. 4 is a schematic view of the boundary faces of representative volume element (RVE) 200. Dividing structures 212, 214, and 216 partition RVE 200 into four discrete regions 218, 220, 222, and 224. Each of dividing structures 212, 214, and 216 is bound by surfaces offset from opposite sides of respective parting surfaces in the same manner as dividing structures 112 and 114 of RVE 100 and dividing structure 12 of RVE 10. In the example shown in FIG. 4, each parting surface is defined by a mathematical expression that equals first, second, and third non-zero constants and each non-zero constant is different from every other non-zero constant. In the depicted embodiment, the mathematical expression defines a Schwarz-D triply periodic minimal surface when equal to zero. Accordingly, dividing structures 212, 214, and 216 have surfaces that have a similar shape and similar contour profile to the Schwarz-D surface but are offset away from the Schwarz-D within RVE 200.

With this arrangement, regions 218, 220, 222, and 224 intersect boundary faces 110a, 110b, 110c, 110d, 110e, and 110f of RVE 200 to define cross-sectional flow areas. FIG. 4 shows cross-sectional flow areas 226a, 226b, and 226e defined by the intersection of region 218 with boundary faces 110a, 110b, and 110e, respectively. While cross-sectional flow areas 226c, 226d, and 226f are not shown in FIG. 4, it is evident that cross-sectional flow areas 226c, 226d, and 226f are defined by the intersection of region 218 with hidden boundary faces 210c, 210d, and 210f, respectively. Similarly, cross-sectional flow areas 228a-f, 230a-f, and 232a-f are defined by intersections of regions 220, 222, and 224 with boundary faces 210a-f, the letter portion of each cross-sectional area reference number shared with the letter portion of each boundary face reference number. Of these cross-sectional areas, areas 228a, 230a, and 232a are shown on boundary face 210a; areas 228b, 230b, and 232b are shown on boundary face 210b; and areas 228e, 230e, and 232e area shown on boundary face 210e. Like RVE 10 and RVE 100, dividing structures 212, 214, and 216 of RVE 200 are triply periodic and enable replication of RVE 200 along mutually orthogonal X, Y, and Z axes of coordinate system 234 to produce a component comprising a continuous structure defined by a repeating pattern of RVEs 200.

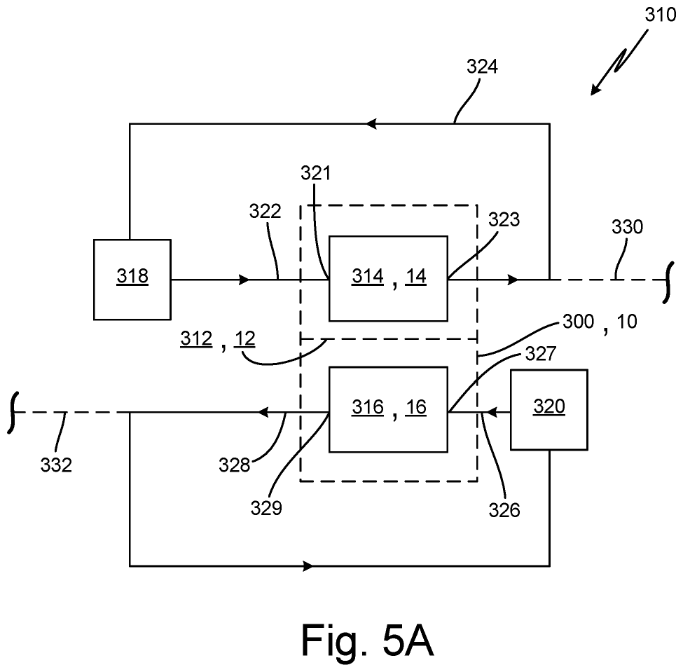

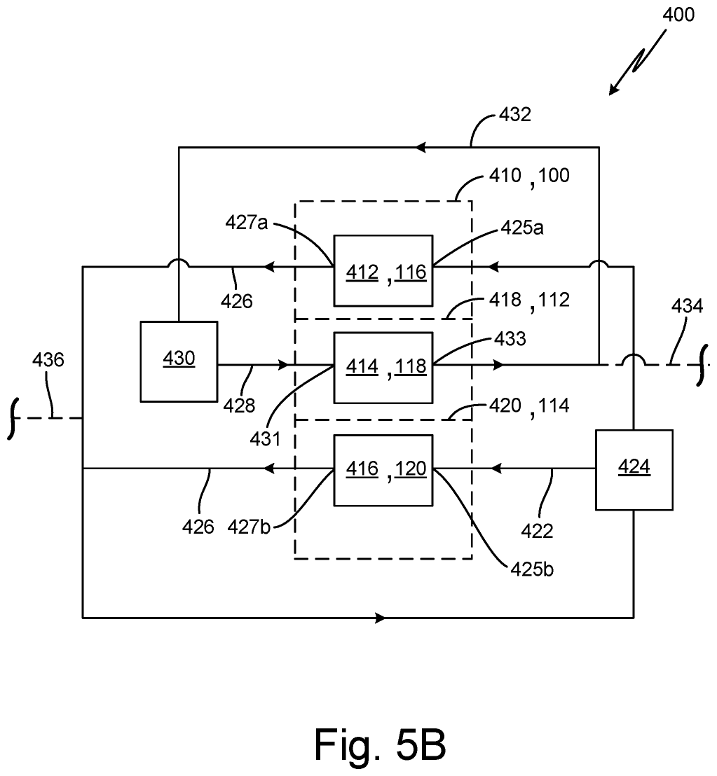

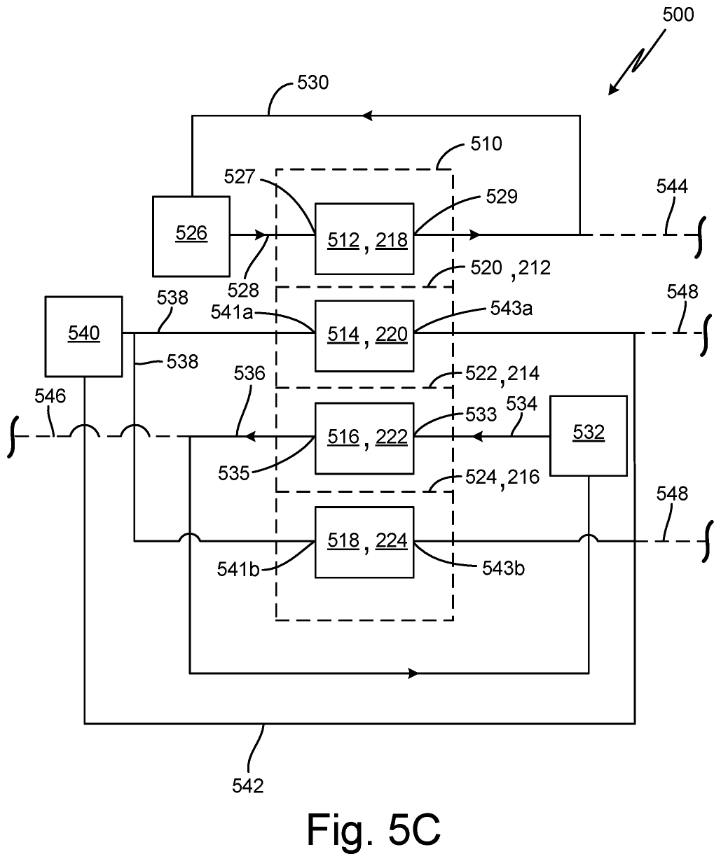

Any of the foregoing representative volume elements as well as other representative volume elements based on a different implicit or explicit surface may be used to form a component comprising a plurality of represent volume elements, and in some embodiments, the component is used to form a heat exchanger core. For example, RVE 10 can be replicated as previously described to create heat exchanger core 300 for use in system 310 schematically depicted by FIG. 5A.

Heat exchanger core 300 includes a plurality of RVEs 10 and consequently, a plurality of dividing structures 12 defining parting wall 312 through which fluid within first fluid path 314 is placed in a heat exchange relationship with another fluid within second fluid path 316. Fluid paths 314 and 316 are defined by parting wall 312 and, more specifically, are formed by a plurality of regions 14 and a plurality of regions 16 interconnected via abutting RVEs 10.

First fluid path 314 is placed in fluid communication with fluid source 318, and second fluid path is placed in fluid communication with fluid source 320, wherein fluid source 318 and fluid source 320 are of different temperature and may be of different material. For example, fluid source 318 may be air while fluid source 320 may be CO₂. Communication between fluid source 318 and inlet 321 of first fluid path 314 is provided with supply line 322 and communication between outlet 323 of first fluid path 314 and fluid source 318 is provided by scavenge line 324. Similarly, supply line 326 fluidly connects source 320 with inlet 327 of second fluid path 316, and scavenge line 328 fluidly connects outlet 329 of second fluid path 316 to fluid source 320.

A first fluid flows from source 318 to first fluid path 314 of heat exchanger core 300 via supply line 322 and returns to fluid source 318 from first fluid path 314 via scavenge line 324. Similarly, a second fluid flows from source 320 to second fluid path 316 of heat exchanger core 300 via supply line 326 and returns to fluid source 320 from second fluid path 316 via scavenge line 328. With this configuration, thermal energy stored within the first fluid flowing through first fluid path 314 can be discharged to the second fluid flowing within second fluid path 316 through parting wall 312. It is understood that thermal energy may be passed from either the first fluid to the second fluid, or from the second fluid to the first fluid, depending on the relative temperatures of each fluid.

As indicated by the flow arrows shown in FIG. 5A, the heat exchanger core has a cross-flow configuration. However, other heat exchanger configurations could be used, for example, a parallel-flow arrangement could be formed by reversing the connections of supply line 326 and scavenge line 328 to second fluid path 316. Additionally, FIG. 5A depicts a simplified and schematic depiction of fluid flows through heat exchanger core 300 as implemented in a closed loop system. An open-loop system is also possible whereby fluid does not return to fluid source 318 and fluid source 320 and, instead, flows through discharge lines 330 and 332, respectively. It shall be understood that systems implementing heat exchanger core 300 shall include one or more of pumps, valves, filters, accumulators, or other components common to heat exchanger systems, but are not shown in FIG. 5A, to facilitate operation of the system.

Further, because dividing structure 12 of RVE 10, from which parting wall 312 of heat exchanger core 300 is formed, partitions RVE 10 into unequal volumes and unequal cross-sections flow areas, the cross-sectional flow area ratio of first fluid path 314 divided by second fluid path 316 can be greater than or less than 1.0 and can be tailored to a particular application. In a particular example where first fluid source 318 is a liquid and second fluid source 320 is a gas, the ratio of cross-sectional flow area through first path 314 divided by the cross-sectional flow area through second path 316 and taken at a common location can be less than 1.0. Thus, more of the available cross-sectional flow area through heat exchanger core 300 can be apportioned to the gaseous flow path (i.e., second path 316) than to the liquid flow path (i.e., first path 314).

FIG. 5B is a schematic representation of system 400 utilizing heat exchanger core 410 formed by a plurality of RVEs 100 and defining first fluid flow path 412, second fluid flow path 414, and third fluid flow path 416. In the depicted embodiment, a first fluid flowing through first fluid path 412 and third fluid flow path 416 is placed in a heat exchange relationship with a second fluid flowing through second fluid flow path 414 by exchanging heat through parting walls 418 and 420. Supply lines 422 provide fluid communication from fluid source 424 to inlet 425a of first fluid path 412 and to inlet 425b of third fluid path 416. Scavenge lines 426 place outlet 427a of first fluid path 412 and outlet 427b of third fluid path 416 in fluid communication with fluid source 424. Similarly, supply line 428 places fluid source 430 in fluid communication with inlet 431 to second fluid path 414, and scavenge line 432 returns fluid from outlet 433 of second fluid path 414 to fluid source 424.

Each parting wall 418 and 420 is formed by a plurality of dividing structures 112 and a plurality of dividing structures 114, respectively. Likewise, first, second, and third fluid paths 412, 414, and 416 are formed by a plurality of regions 116, 118, and 120, respectively. As such, second fluid path 414 is disposed between first fluid path 412 and third fluid path 416. The cross-sectional flow area ratio between the first fluid flow path and the second fluid flow path can be expressed as the summation of cross-sectional areas of first fluid path 412 and third fluid flow path 416 divided by the cross-sectional area of second fluid path 414, which in the depicted example, is greater than 1.0.

FIG. 5C is schematic representation of system 500 that includes heat exchanger core 510 formed by a plurality of RVEs 200 and defining first, second, third, and fourth fluid paths 512, 514, 516, and 518. Due to the periodic structure of RVE 200, first, second, third, and fourth fluid paths 512, 514, 516, and 518 are formed by pluralities of first, second, third, and fourth regions 218, 220, 222, and 224, respectively. Similarly, parting walls 520, 522, and 524 are defined by pluralities of dividing structures 212, 214, and 216, respectively. As such, parting wall 520 divides first fluid path 512 from second fluid flow path 514 and, when viewed in light of FIG. 4, divides first fluid path 512 from fourth fluid path 518. Parting wall 522 divides second fluid path 514 from third fluid path 516, and parting wall 524 divides third fluid path 516 from fourth fluid path 518.

In the depicted embodiment, fluid flowing through first fluid path 512 is placed in a heat exchange relationship with fluid flowing through third fluid flow path 514. Additionally, second fluid path 514 and fourth fluid path 518 are supplied with an inert gas (e.g., nitrogen or air), or inert fluid. For this purpose, fluid source 526 is placed in fluid communication with inlet 527 of first fluid path 512 via supply line 528 and returns from outlet 529 of first fluid path 512 to fluid source 526 via scavenge line 530. Fluid from fluid source 532 is delivered to inlet 533 of third fluid path 516 via supply line 534 and returns from outlet 535 of third fluid path 526 via scavenge line 536. Supply lines 538 provide inert gas or fluid from source 540 to inlets 541a and 541b of second and fourth fluid paths 514 and 518. Scavenge lines 542 return the inert gas or fluid from outlets 543a and 543b of second and fourth fluid paths 514 and 518 to source 540.

Alternatively, fluid from source 526 and fluid from source 532 are not required to return through scavenge lines 530 and 536 and, instead, may be discharged from the heat exchanger system via lines 544 and 546 as shown. Further, fluid originating from source 540 may stagnate within second and fourth flow paths 514, 518, eliminating the need for scavenge lines 542. Alternatively, fluid from source 540 may be discharged through one or more lines 548 in an open loop arrangement.

With any of the foregoing arrangements of system 500, a volatile or combustible fluid (e.g., fuel) can be separated from another fluid (e.g., lubricating oil). Furthermore, second and fourth fluid paths 514 and 518 can be equipped with sensors to detect leakage of one or both of the first fluid and second fluid into second and fourth fluid paths.

Any of the foregoing components or heat exchanger cores can be manufacturing using additive manufacturing techniques such as selective laser sintering (DLS), direct metal laser sintering (DMLS), and selective laser melting (SLM) techniques, among other additive manufacturing techniques known in the art.

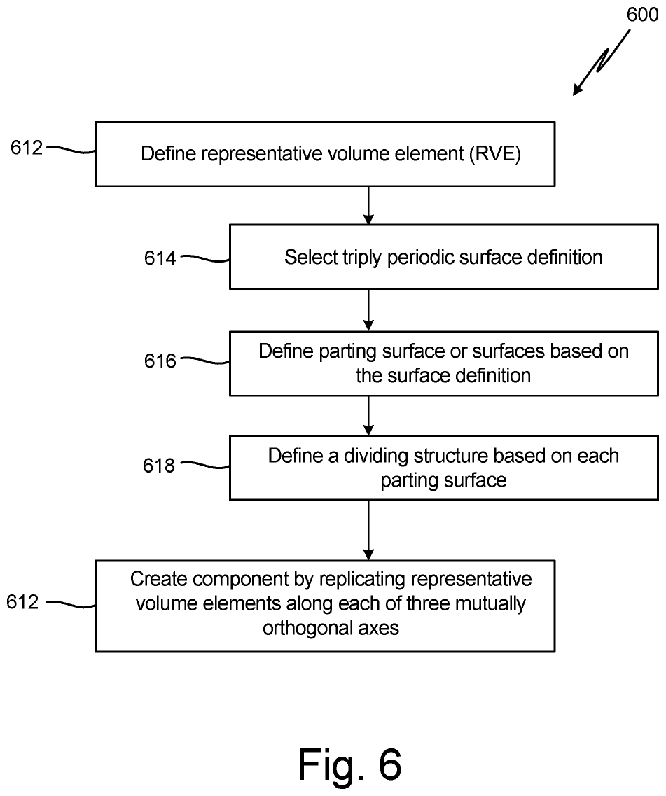

FIG. 6 is a schematic representation of method 600 summarizing steps forming a component comprising a plurality of any one of the foregoing representative volume elements. Method 600 includes defining a representative volume element in step 610 and creating a component by replicating the representative volume element along each of three mutually orthogonal directions in step 612. Defining the representative volume element in step 610 can be further refined by including any one or more of the following steps 614, 616, and 618.

In step 614, a triply periodic surface is selected to define a general shape and contour profile of the dividing structure of the representative volume element. In some embodiments, the surface is a triply periodic minimal surface. In both instances, the periodic surface can be defined by a mathematical expression that defines a surface in three-dimensional space and equals zero, sometimes referred to as a zero surface. When the periodic surface divides the representative volume element into equal volumes and equal cross-sectional areas, a triply periodic minimal surface can be used. Example triply periodic minimal surfaces suitable for this method include the Schwarz D, Schoen-G, Schwarz-P, and Schoen IWP surfaces given by equations 1, 2, 3, and 4, although other triply periodic minimal surfaces could be derived for this purpose.

In step 616, at least one parting surface is defined using the mathematical expression selected during step 614. For example, RVEs 10, 100, and 200 are all based on the Schwarz-D surface given by equation 1. The parting surface is defined by offsetting the Schwarz-D surface, or the zero surface, in the RVE by setting the mathematical expression of a Schwarz-D surface equal to a non-zero constant. If additional parting surfaces are desired, each additional parting surface is defined by setting the same mathematical expression equal to different non-zero constants. The number of parting surfaces and the non-zero constants defining each parting surface can be selected based on the desired area ratio or ratios between cross-sectional flow areas of two regions of the RVE.

The dividing structure associated with each parting surface is defined by thickening the parting surface in step 618. In other words, bounding surfaces of each dividing structure are defined by offsetting points on the parting surface in opposite directions along a vector normal the parting surface such that each point on the bounding surfaces is spaced from the parting surface by the same distance.

Representative volume elements formed in accordance with method 600 have two or more discrete regions of unequal volume and unequal cross-sectional flow areas. Such RVEs facilitate building components with cross-sectional flow area ratios greater than or less than 1.0, and are particularly useful for constructing heat exchanger cores. Such heat exchanger cores provide relatively high surface area available for heat transfer while reducing pressure losses produced by flows through the heat exchanger core and benefiting from the efficiency improvements of heat exchangers with cross-sectional flow area ratios greater than or less than 1.0.

### DISCUSSION OF POSSIBLE EMBODIMENTS

The following are non-exclusive descriptions of possible embodiments of the present invention.

A component according to an exemplary embodiment of this disclosure, among other possible things, includes a plurality of representative volume elements. Each of the plurality representative volume elements abuts at least one other representative volume element of the plurality of representative volume elements to form the component. Additionally, each of the plurality of representative volume elements includes a first dividing structure.

The component of the preceding paragraph can optionally include, additionally and/or alternatively, any one or more of the following features, configurations and/or additional components:

A further embodiment of the foregoing component, wherein the first dividing structure can be bound by a first surface defined by a first parting surface offset in a first direction and a second surface defined by the first parting surface offset in a second direction opposite the first direction.

A further embodiment of any of the foregoing components, wherein the first parting surface can be defined by a mathematical expression that equals a first constant.

A further embodiment of any of the foregoing components, wherein the first constant can be equal to a non-zero first constant.

A further embodiment of any of the forgoing components, wherein the first dividing structure can partition each of the plurality of representative volume elements into discrete first and second regions.

A further embodiment of any of the forgoing components can further comprise a second dividing structure.

A further embodiment of any of the forgoing components, wherein the second dividing structure can be bound by a third surface defined by a second parting surface offset in the first direction and a fourth surface defined by the second parting surface offset in the second direction.

A further embodiment of any of the foregoing components, wherein the second parting surface is defined by the mathematical expression that equals a second constant different from the first constant to define the second parting surface.

A further embodiment of any of the foregoing components, wherein the second constant can be equal to a non-zero second constant.

A further embodiment of any of the foregoing components, wherein the first and second dividing structures partition each of the plurality of representative volume elements into discrete first, second, and third regions.

A further embodiment of any of the foregoing components can further include a third dividing structure.

A further embodiment of any of the foregoing components, wherein the third dividing structure can be bound by a fifth surface defined by a third parting surface offset in the first direction and a sixth surface defined by the third parting surface offset in the second direction.

A further embodiment of any of the foregoing components, wherein the third parting surface can be defined by the mathematical expression that equals a third constant different from each of the first and second constants.

A further embodiment of any of the foregoing components, wherein the third constant can be equal to a non-zero third constant.

A further embodiment of any of the foregoing components, wherein the first, second, and third dividing structures can partition each of the plurality of representative volume elements into discrete first, second, third, and fourth regions.

A further embodiment of any of the foregoing components, wherein each of the first and second constants can be positive values or negative values.

A further embodiment of any of the foregoing components, wherein one of the first and second constants can be a positive value and the other one of the first and second constants can be a negative value.

A further embodiment of any of the foregoing components, wherein the first and second constants can have the same magnitude.

A further embodiment of any of the foregoing components, wherein the component forms a heat exchanger core.

A system according to another exemplary embodiment of this disclosure, among other possible things, includes a heat exchanger core formed by a plurality of representative volume elements. Each of the plurality of representative volume elements abuts at least one other representative volume element of the plurality of representative volume elements to form the heat exchanger core. Each of the plurality representative volume elements includes a first dividing structure.

The system of the preceding paragraph can optionally include, additionally and/or alternatively, any one or more of the following features, configurations and/or additional components:

A further embodiment of the foregoing system, wherein the first dividing structure can be bound by a first surface defined by a first parting surface offset in a first direction and a second surface defined by the first parting surface offset in a second direction opposite the first direction.

A further embodiment of any of the foregoing systems, wherein the first parting surface can be defined by a mathematical expression that equals a first constant.

A further embodiment of any of the foregoing systems, wherein the first constant can equal a non-zero first constant.

A further embodiment of any of the forgoing systems, wherein the first dividing structure can partition each of the plurality of representative volume elements into discrete first and second regions.

A further embodiment of any of the forgoing systems can further comprise a second dividing structure.

A further embodiment of any of the forgoing systems, wherein the second dividing structure can be bound by a third surface defined by a second parting surface offset in the first direction and a fourth surface defined by the second parting surface offset in the second direction.

A further embodiment of any of the foregoing systems, wherein the second parting surface is defined by the mathematical expression, and wherein the mathematical expression equals a second constant different from the first constant to define the second parting surface.

A further embodiment of any of the foregoing systems, wherein the second constant can be a non-zero second constant.

A further embodiment of any of the foregoing systems, wherein the first and second dividing structures partition each of the plurality of representative volume elements into discrete first, second, and third regions.

A further embodiment of any of the foregoing systems can further include a third dividing structure.

A further embodiment of any of the foregoing systems, wherein the third dividing structure can be bound by a fifth surface defined by a third parting surface offset in the first direction and a sixth surface defined by the third parting surface offset in the second direction.

A further embodiment of any of the foregoing systems, wherein the third parting surface can be defined by the mathematical expression, and wherein the mathematical expression equals a third constant different from each of the first and second constants to define the third parting surface.

A further embodiment of any of the foregoing systems, wherein the third constant can be a non-zero third constant.

A further embodiment of any of the foregoing systems, wherein the first, second, and third dividing structures can partition each of the plurality of representative volume elements into discrete first, second, third, and fourth regions.

A further embodiment of any of the foregoing systems, wherein each of the first and second constants can be positive values or negative values.

A further embodiment of any of the foregoing systems, wherein one of the first and second constants can be a positive value and the other one of the first and second constants can be a negative value.

A further embodiment of any of the foregoing systems, wherein the first and second constants can have the same magnitude.

A further embodiment of any of the foregoing systems can further include a first fluid source and a second fluid source.

A further embodiment of any of the foregoing systems, wherein the first fluid source fluidly communicates with the first region of at least one of the plurality of representative volume elements and the second fluid source fluidly communicates with the second region of the at least one of the plurality of representative volume elements or the second fluid source fluidly communicates with the first region of at least one of the plurality of representative volume elements and the first fluid source fluidly communicates with the second region of the at least one of the plurality of representative volume elements.

A further embodiment of any of the foregoing systems, wherein the first region can intersect a boundary face of each of the plurality representative volume elements to define a first cross-sectional area, and wherein the second region can intersect the boundary face of each of the plurality of representative volume elements to define a second cross-sectional area, and wherein an area ratio of the first cross-sectional area divided by the second cross-sectional area is greater than or less than 1.0.

A further embodiment of any of the foregoing systems, wherein the first fluid source can be in fluid communication with the first and third regions of at least one of the plurality of representative volume elements, and wherein the second fluid source can be in fluid communication with the second region of the at least one of the plurality of representative volume elements or wherein the first fluid source can be in fluid communication with the second region of at least one of the plurality of representative volume elements, and wherein the second fluid source can be in fluid communication with the first and third regions of the at least one of the plurality of representative volume elements.

A further embodiment of any of the foregoing systems, wherein the second region can be disposed between the first and third regions, and wherein the first, second, and third regions can intersect a boundary face of each of the plurality of representative volume elements to define first, second, and third cross-sectional areas, respectively, and wherein an area ratio equal to the summation of the first and third cross-sectional areas divided by the second cross-sectional area is greater than or less than 1.0.

A further embodiment of any of the foregoing systems, wherein the first fluid source can be in fluid communication with the first region of at least one of the plurality of representative volume elements, and wherein the second fluid source can be in fluid communication with the third region of the at least one of the plurality of volume elements, and wherein a third fluid source can be in fluid communication with the second and fourth regions of the at least one of the plurality of representative volume elements.

A further embodiment of any of the foregoing systems, wherein the second region can be disposed between the first and third regions and the fourth region can be disposed between the first and third regions, and wherein the first, second, third, and fourth regions intersect a boundary face of each of the plurality of representative volume elements to define first, second, third, and fourth cross-sectional areas, respectively, and wherein an area ratio can equal to the first cross-sectional area divided by the third cross-sectional area is greater than or less than 1.0.

A further embodiment of any of the foregoing systems, wherein the second cross-sectional area can be equal to the fourth cross-sectional area.

A further embodiment of any of the foregoing systems, wherein each of the second cross-sectional area and the fourth cross-sectional area are less than each of the first cross-sectional area and the third cross-sectional area.

A method of manufacturing a component comprising a plurality of representative volume elements according to another exemplary embodiment of this disclosure, among other possible things, includes defining a representative volume element of the plurality of representative volume elements and creating the component by replicating the representative volume element along each of three mutually orthogonal directions.

The method of the preceding paragraph can optionally include, additionally and/or alternatively, any one or more of the following features, steps, configurations and/or additional components:

A further embodiment of the foregoing method, wherein defining the representative volume element can further include selecting a triply periodic surface expressed as a mathematical expression that equals zero.

A further embodiment of the foregoing method, wherein defining the representative volume element can further include selecting a triply periodic minimal surface expressed as a mathematical expression that equals zero.

A further embodiment of any of the foregoing methods, wherein defining the representative volume element can further include defining a first parting surface expressed as the mathematical expression that equals a first constant.

A further embodiment of any of the foregoing methods, wherein the first constant can be a non-zero first constant.

A further embodiment of any of the foregoing methods, wherein defining the representative volume element can further include defining a first surface of a first dividing structure by offsetting the first parting surface in a first direction.

A further embodiment of any of the foregoing methods, wherein defining the representative volume element can further include defining a second surface of the first dividing structure by offsetting the first parting surface in a second direction that is opposite the first direction.

A further embodiment of any of the foregoing methods, wherein defining the representative volume element can further include defining the first dividing structure of the representative volume element based on the first surface and the second surface.

A further embodiment of any of the foregoing methods, wherein defining the representative volume element can further include selecting the first constant based on an area ratio equal to a first cross-sectional area divided by a second cross-sectional area, and wherein the first dividing structure partitions the representative volume element into discrete first and second regions, and wherein the first and second regions intersect a boundary face of the representative volume element to define the first cross-sectional area and the second cross-sectional area, respectively.

A further embodiment of any of the foregoing methods, wherein defining the representative volume element can further include defining a second dividing structure.

A further embodiment of any of the foregoing methods, wherein defining the representative volume element can further include defining a second parting surface defined by the mathematical expression equal to a second constant different from the first constant.

A further embodiment of any of the foregoing methods, wherein the second constant can be a non-zero second constant.

A further embodiment of any of the foregoing methods, wherein defining the representative volume element can further include defining a third surface of the second dividing structure by offsetting the second parting surface in the first direction.

A further embodiment of any of the foregoing methods, wherein defining the representative volume element can further include defining a fourth surface of the second dividing structure by offsetting the second parting surface in the second direction.

A further embodiment of any of the foregoing methods, wherein the second dividing structure can be defined based on the third and fourth surfaces.

A further embodiment of any of the foregoing methods, wherein defining the representative volume element can further include selecting the first and second constants based on an area ratio equal to the summation of first and third cross-sectional areas divided by a second cross-sectional area, and wherein the first and second dividing structures partition the representative volume element into discrete first, second, and third regions, and wherein the first, second, and third regions intersect a boundary face of the representative volume element to define the first, second, and third cross-sectional areas, respectively.

A further embodiment of any of the foregoing methods, wherein defining the representative volume element can further include defining a third dividing structure.

A further embodiment of any of the foregoing methods, wherein defining the representative volume element can further include defining a third parting surface defined by the mathematical expression equal to a third constant different from the first constant and different from the second constant.

A further embodiment of any of the foregoing methods, wherein the third constant can be a non-zero third constant.

A further embodiment of any of the foregoing methods, wherein defining the representative volume element can further include defining a fifth surface of the third dividing structure by offsetting the third parting surface in the first direction.

A further embodiment of any of the foregoing methods, wherein defining the representative volume element can further include defining a sixth surface of the third dividing structure by offsetting the third parting surface in the second direction.

A further embodiment of any of the foregoing methods, wherein defining the third dividing structure can be based on the fifth surface and the sixth surface.

A further embodiment of any of the foregoing methods, wherein defining the representative volume element can further include selecting the first, second, and third constants based on an area ratio equal to a first cross-sectional area divided by a third cross-sectional area, and wherein the first, second, and third dividing structures partition each representative volume element into discrete first, second, third, and fourth regions, and wherein the second region is disposed between the first and third regions, and wherein the fourth region is disposed between the first and third regions, and wherein the first, second, third, and fourth regions intersect a boundary face of the representative volume element to define the first, second, third, and fourth cross-sectional areas, respectively.

A further embodiment of any of the foregoing methods, wherein defining the representative volume element can further include selecting first, second, third, and fourth constants based on equal second and fourth cross-sectional areas.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A component comprising:
a plurality of representative volume elements, each representative volume element of the plurality of representative volume elements abutting at least one other representative volume element of the plurality of representative volume elements and each representative volume element of the plurality of representative volume elements comprising:
a first parting surface defined by a mathematical expression that equals a non-zero first constant, wherein a triply periodic surface is defined by the mathematical expression equaling zero;
a first surface defined by the first parting surface offset in a first direction;
a second surface defined by the first parting surface offset in a second direction opposite the first direction; and
a first dividing structure bound by the first and second surfaces.

2. The component of claim 1,
wherein the first dividing structure partitions each of the plurality of representative volume elements into discrete first and second regions.

3. The component of claim 1, wherein each of the plurality of representative volume elements further comprises:
a second parting surface defined by the mathematical expression, wherein the mathematical expression equals a non-zero second constant different from the first constant;
a third surface defined by the second parting surface offset in the first direction;
a fourth surface defined by the second parting surface offset in the second direction; and
a second dividing structure bound by the third and fourth surfaces.

4. The component of claim 3, wherein the first and second dividing structures partition each of the plurality of representative volume elements into discrete first, second, and third regions.

5. The component of claim 3, wherein each of the plurality of representative volume elements further comprises:
a third parting surface defined by the mathematical expression, wherein the mathematical expression equals a non-zero third constant different from each of the first and second constants;
a fifth surface defined by the third parting surface offset in the first direction;
a sixth surface defined by the third parting surface offset in the second direction; and
a third dividing structure bound by the fifth and sixth surfaces.

6. The component of claim 5, wherein the first, second, and third dividing structures partition each of the plurality of representative volume elements into discrete first, second, third, and fourth regions.

7. The component of claim 3, wherein each of the first and second constants are positive values or negative values.

8. The component of claim 3, wherein one of the first and second constants is a positive value and the other one of the first and second constants is a negative value, and wherein the first and second constants have the same magnitude.

9. A system comprising:
a heat exchanger core formed by the component of claim 2;
a first fluid source in fluid communication with the first region of at least one of the plurality of representative volume elements; and
a second fluid source in fluid communication with the second region of the at least one of the plurality of representative volume elements;
wherein the first region intersects a boundary face of each of the plurality of representative volume elements to define a first cross-sectional area, and the second region intersects the boundary face of each of the plurality of representative volume elements to define a second cross-sectional area; and
wherein an area ratio of the first cross-sectional area divided by the second cross-sectional area is greater than or less than 1.0.

10. A system comprising:
a heat exchanger core formed by the component of claim 4, wherein the second region is disposed between the first and third regions;
a first fluid source in fluid communication with the first and third regions of at least one of the plurality of representative volume elements; and
a second fluid source in fluid communication with the second region of the at least one of the plurality of representative volume elements;
wherein the first, second, and third regions intersect a boundary face of each of the plurality of representative volume elements to define first, second, and third cross-sectional areas, respectively; and
wherein an area ratio equal to the summation of the first and third cross-sectional areas divided by the second cross-sectional area is greater than or less than 1.0.

11. A system comprising;
a heat exchanger core formed by the component of claim 6, wherein the second region is disposed between the first and third regions, and the fourth region is disposed between the first and third regions;
a first fluid source in fluid communication with the first region of at least one of the representative volume elements;
a second fluid source in fluid communication with the third region of the at least one of the plurality of representative volume elements; and
a third fluid in fluid communication with the second and fourth regions of the at least one of the plurality of representative volume elements;
wherein the first, second, third, and fourth regions intersect a boundary face of each of the plurality of representative volume elements to define first, second, third, and fourth cross-sectional areas, respectively; and
wherein an area ratio equal to the first cross-sectional area divided by the third cross-sectional area is greater than or less than 1.0.

12. The system of claim 11,
wherein the second cross-sectional area is equal to the fourth cross-sectional area; and
wherein the second and fourth cross-sectional areas are less than each of the first and third cross-sectional areas.

13. A method of manufacturing a component comprising a plurality of representative volume elements, the method comprising:
defining a representative volume element comprising:
defining a first parting surface defined by a mathematical expression that equals a non-zero first constant, wherein a triply periodic surface is defined when the mathematical expression equals zero;
defining a first surface of a first dividing structure by offsetting the first parting surface in a first direction;
defining a second surface of the first dividing structure by offsetting the first parting surface in a second direction that is opposite the first direction; and
defining the first dividing structure of the representative volume element based on the first and second surfaces;
creating the component by replicating the representative volume element along each of three mutually orthogonal directions.

14. The method of claim 13, wherein defining the representative volume element further comprises:
selecting the first constant based on an area ratio equal to a first cross-sectional area divided by a second cross-sectional area;
wherein the first dividing structure partitions the representative volume element into discrete first and second regions; and
wherein the first and second regions intersect a boundary face of the representative volume element to define the first cross-sectional area and the second cross-sectional area, respectively.

15. The method of claim 13, wherein defining the representative volume element further comprises:
defining a second parting surface according to the mathematical expression, wherein the mathematical expression equals a non-zero second constant different from the first constant;
defining a third surface of a second dividing structure by offsetting the second parting surface in the first direction;
defining a fourth surface of the second dividing structure by offsetting the second parting surface in the second direction; and
defining the second dividing structure of the representative volume element based on the third and fourth surfaces.

16. The method of claim 15, wherein defining the representative volume element further comprises:
selecting the first and second constants based on an area ratio equal to a summation of first and third cross-sectional areas divided by a second cross-sectional area;
wherein the first and second dividing structures partition the representative volume element into discrete first, second, and third regions; and
wherein the first, second, and third regions intersect a boundary face of the representative volume element to define the first, second, and third cross-sectional areas, respectively.

17. The method of claim 15, wherein defining the representative volume element further comprises:
defining a third parting surface according to the mathematical expression, wherein the mathematical expression equals a non-zero third constant different from the first and second constants;
defining a fifth surface of a third dividing structure by offsetting the third parting surface in the first direction;
defining a sixth surface of the third dividing structure by offsetting the third parting surface in the second direction; and
defining the third dividing structure of the representative volume element based on the fifth and sixth surfaces.

18. The method of claim 17, wherein defining the representative volume element further comprises:
selecting the first, second, and third constants based on an area ratio equal to a first cross-sectional area divided by a third cross-sectional area;
wherein the first, second, and third dividing structures partition each representative volume element into discrete first, second, third, and fourth regions;
wherein the second region is disposed between the first and third regions,
wherein the fourth region is disposed between the first and third regions; and
wherein the first, second, third, and fourth regions intersect a boundary face of the representative volume element to define the first, second, third, and fourth cross-sectional areas, respectively.

19. The method of claim 18, wherein defining the representative volume element further comprises:
selecting first, second, third, and fourth constants based on equal second and fourth cross-sectional areas.

20. The method of claim 13, wherein the triply periodic surface defined when the mathematical expression equals zero is one of a Schwarz-D surface, a Schoen-G surface, a Schwarz-P surface, and a Schoen-IWP surface.
